(19) United States
(12) Patent Application Publication
(10) Pub. No.: US 2011/0165864 A1
(43) Pub. Date: Jul. 7, 2011

(54) APPARATUS AND METHOD FOR DETERMINING COMPATIBILITY BETWEEN SERVICES AND MOBILE DEVICES

(75) Inventor: Noam Guzman, Tel Aviv (IL)

(73) Assignee: RETALIKA, LTD., Tel-Aviv (IL)

(21) Appl. No.: 12/651,567

(22) Filed: Jan. 4, 2010

(51) Int. Cl. H04M 3/42; G06F 17/30

(52) U.S. Cl. 455/414.1; 707/769; 707/705; 707/E17.108

(57) ABSTRACT

A method for determining compatibility between a service to a mobile device includes selecting at least one source of information for information respective of at least one of capabilities of the mobile device and requirements of the service; retrieving the information respective of the at least one of capabilities of the mobile device and requirements of the service from the at least one source of information; determining a predictive compatibility score (PCS) for a pair of the mobile device and the service based on the retrieved information; and storing the PCS in a compatibility matrix at a position corresponding to the intersection of the mobile device and the service, wherein the compatibility matrix contains a PCS for each pair of mobile device and service if information is available to make a PCS determination for such a pair.

### TECHNICAL FIELD

The invention generally relates to the field of mobile devices capable of executing one or more services, and more particularly the compatibility of services with mobile devices and vice versa.

### BACKGROUND OF THE INVENTION

Mobile devices, such as personal digital assistants (PDAs), smart phones, and cellular phones, have become common place in the last decade and a half. The advances in the capabilities of such devices enable beyond the telephony features to equip the mobile device with a slew of services that make the use of the mobile device more convenient and attractive to its user, turning it into an essential working tool. The ability to browse the web using the mobile device further extends the web experience into the mobile environment, giving users new ways to communicate on the go. A typical mobile device is capable of executing many different services installed thereon. Generally, in order to install a service on a mobile device it is necessary to ensure it is operable on the mobile device. Services may be, but are not limited to, applications (apps) such as are commonly and commercially used with the iPhone® and BlackBerry® smart phones.

The advances in mobile devices are rapid and therefore users frequently add new services to their mobile devices or otherwise replace their old mobile device by a new one. This happens frequently and is encouraged by both service providers as well as by the users who want to take advantage of the more advanced features newer services and/or newer mobile devices may provide. The abundance of services available for mobile devices and the abundance of potential mobile devices, but certainly not all, available to execute these services presents particular challenges. In order to verify that a service is operable on a specific mobile device it is necessary to perform a test, at times an exhaustive test, to ensure that full compatibility exists. A service provider is not likely to ascertain that a service is operable on a mobile device unless it was actually tested by the provider or developer of the service. Likewise, a mobile device provider is unlikely to ascertain that a mobile device it manufactured is capable of operating a service unless actively tested. The test parameters required for extensive testing are significant and costly. It is therefore common to find that a service is certified for operability on a limited number of mobile devices, and likewise, a mobile device is certified to execute only a limited number of devices. However, it is also common to find that a service executes on a mobile device even if not certified or even tested to perform thereon.

The problem is further magnified when a user wants to transfer the services installed on an old mobile device to a new mobile device. Not only is it a pain to the users, but also to providers of the services as well as the retailers attempting to provide a painless and effective service when a user moves from one mobile device to another. The providers of services fear that at the mobile device change opportunity, a user may be inclined to drop the service they provided in favor of another one, especially if the transfer process is not straightforward. This is of particular concern when an executable code is installed on the old mobile device which may not be possible to be transferred in this format to the new mobile device. U.S. Pat. No. 7,451,441 to Carter et al. suggests the use of a product configuration matrix installed on each device and which provides identification information about which software can be installed on the device. However, this solution limits the installation of services on a particularly device to those which are approved in advance for use, and still is limited in scope and agility. On top of that all, even when a service provider states that a service is compatible with a certain device this is not always true due to bugs, errors, omissions and other shortfalls that make the service non-functional or limited on the mobile device.

Therefore, it would be advantageous to provide a solution for enabling efficient and effective prediction of compatibility of services for mobile devices.

### SUMMARY OF THE INVENTION

Certain embodiments of the invention include a method for determining compatibility between a service to a mobile device. The method comprises selecting at least one source of information for information respective of at least one of capabilities of the mobile device and requirements of the service; retrieving the information respective of the at least one of capabilities of the mobile device and requirements of the service from the at least one source of information; determining a predictive compatibility score (PCS) for a pair of the mobile device and the service based on the retrieved information; and storing the PCS in a compatibility matrix at a position corresponding to the intersection of the mobile device and the service, wherein the compatibility matrix contains a PCS for each pair of mobile device and service if information is available to make a PCS determination for such a pair.

Certain embodiments of the invention also include an apparatus for determining compatibility between a service and a mobile device. The apparatus comprises a system server for accessing at least one source of information for retrieving information about at least one of capabilities of the mobile device and requirements of the service and determining a predictive compatibility score (PCS) based on the retrieved information, wherein the PCS provides an indication on an ability of the service to successfully execute on the mobile device; and a database connected to the system server and containing a two dimensional compatibility matrix, wherein the PCS is stored in the compatibility matrix.

### BRIEF DESCRIPTION OF THE DRAWINGS

The subject matter that is regarded as the invention is particularly pointed out and distinctly claimed in the claims at the conclusion of the specification. The foregoing and other objects, features and advantages of the invention will be apparent from the following detailed description taken in conjunction with the accompanying drawings.

FIG. 1 is a system implemented in accordance with the principles of the invention.

FIG. 2 is a first embodiment of a matrix of information regarding services and models of mobile devices stored in the database of the system.

FIG. 3 is a second embodiment of a matrix of information regarding services and models of mobile devices stored in the database of the system.

FIG. 4 is a flowchart depicting a method for generating a matrix of information in accordance with the principles of the invention.

### DETAILED DESCRIPTION OF THE INVENTION

It is important to note that the embodiments disclosed by the invention are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

The abundance of mobile and other handheld devices, utilize a plurality of variations of operating systems and Java platforms, posing significant compatibility challenges. A mobile device today has the power to operate a plurality of services that may be installed on the mobile device. Services are checked to be operative on a limited number of devices and are approved for operation thereon. Certain exemplary embodiments enable predictive determination of the operability of a service on a given device based on the device and the service characteristics and requirements and vice versa. This maybe further used to add new devices to a list of existing services as well as adding services to a list of existing devices. Knowledge of the requirements of the services and the devices and the respective operability enable prediction of usability of a service on an untested device.

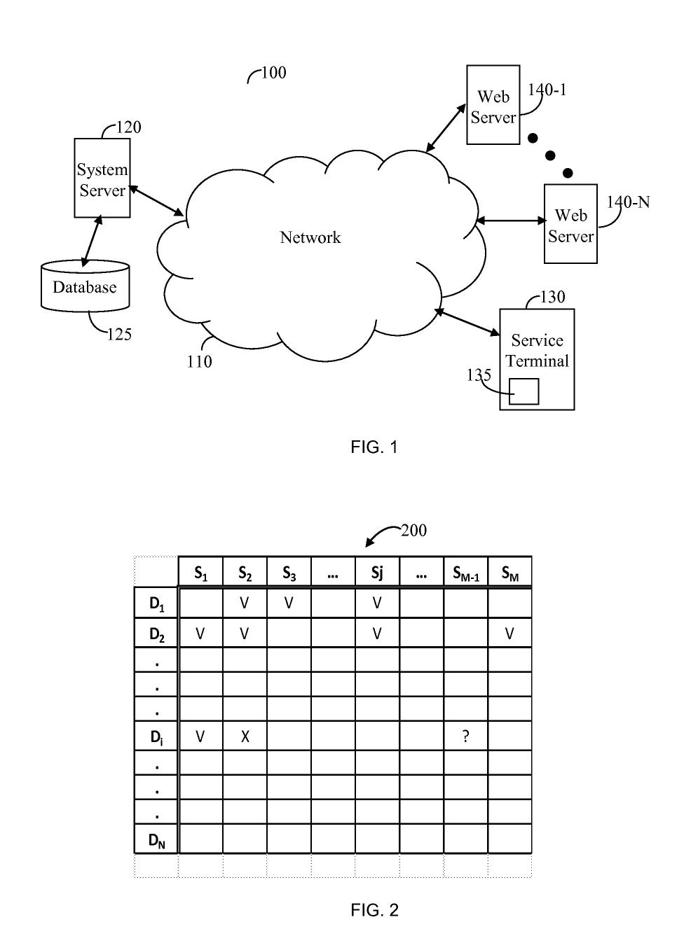

FIG. 1 shows an exemplary and non-limiting system 100 implemented in accordance with the principles of the invention. The system 100 comprises a network 110 that may comprise one or more communication elements including, but not limited to, a local area network (LAN), a wide area network (WAN), a metro area network (WAN), the Internet, the worldwide web (WWW), a wireless network, a cellular network, and the like. To the network 110 there is connected a system server 120 that is connected to a database 125. The database 125 may be connected the system server 120 through a dedicated communication link or through the network 110. Other embodiments for connecting the database 125 to the system server 120 should be apparent to one of ordinary skill in the art.

The system server 120 is enabled to search for information respective of, but not limited to, mobile devices as well as services that may be installed on such devices. A plurality of web servers 140 may be communicatively connected to the network 110, and be the source for such information, by having the system server 120 periodically checking for information on one or more of the web servers 140. A service terminal 130, coupled to network 110, having a tangible medium 135 for storing instructions utilized for managing the system server 120 and database 125. For example, the instructions may provide certain manual inputs or otherwise overrides to a matrix stored in the database 125 in accordance with the principles of the invention, discussed in more detail herein below.

One or more mobile devices (not shown) may also be connected to the network 110. The system server 120 may be enabled to access such mobile devices for the purpose of checking their capabilities and requirements, as well as the operability of a service on the mobile devices. Responsive to the collection of such information the system server 120 is enabled to generate a predictive compatibility score (PCS) which determines the degree of compatibility between a service and a mobile device and vice versa. The PCS is predictive because not in all cases a determination of compatibility is a result of an extensive compatibility test of the service on the particular device made by the manufacturer or the developer, if at all. It may be a prediction of compatibility based on knowledge collected from the information sources and reduced to a single PCS indication.

The PCS enables to predict degree of compatibility based on gathered and available information. The degree of compatibility determines the likelihood of a service to be operable on a certain mobile device, even if no testing was performed or is known to be performed thereon. The gathered and available information may exist from a provider of a service, a manufacturer of a mobile device, and reports of incompatibilities, partial or full non-functionality, failures and the like. All such information is used to for the purpose of the determination of the PCS. The evaluation of compatibility is also performed by comparing the mobile device to other related mobile devices, for example mobile devices that belong to the same family of products according to its manufacturer, or that appear under a different brand name, and which are compatible to a service. In addition, similar comparison may be performed from the service perspective. Therefore, in one embodiment on the invention a mobile devices relations matrix is used to show relations between different mobile devices and/or a services relations matrix used to show relations between different services.

FIG. 2 shows an exemplary and non-limiting compatibility matrix 200 generated in accordance with an embodiment of the invention. The compatibility matrix 200 is stored in the database 125 comprises a plurality of a number of N rows (N is an integer number equal to or greater than 1), each row represents a different mobile device model, for example mobile device model Di. The compatibility matrix 200 further comprises a number of M columns (M is an integer number equal to or greater than 1), each column represents a different service, for example service Sⱼ.

Due to differences between the different mobile device models D and the requirements of the different services S, not all device models D are capable of executing all services S. Therefore, the compatibility matrix 200 is filled with a PCS regarding the compatibility between a model D and a service S. In this embodiment the PCS is in a form of a symbol or a string and a discrete number. For example, definite compatibility may be shown as a ‘V’ or ‘compatible’, definite incompatibility as an ‘X’ or ‘incompatible’ and inconclusive or unknown compatibility as a ‘?’, ‘maybe’, or just left blank respectively. Such exemplary information is shown in the compatibility matrix 200. Accordingly, a mobile device model D₁ is compatible with the services S₂, S₃ and Sⱼ, while model D₂ is compatible with services S₁, S₂, Sⱼ and S_{M}. A mobile device model Dᵢ is compatible with S₁, not compatible with S₂ and has unknown compatibility with S_{M-1}. Hence, a user owning mobile device model D₁ is assured of the operability of the services S₂ and Sⱼ, but not service S_{M}. A user requiring the service S₂ will probably not consider device Dⱼ as there is not compatibility found of that device with respect to service S₂. In the exemplary matrix 200 the blank cells represent the case where no determination was made with respect to the compatibility, for example, in the case where no information was available with respect of the pair, or for some other reason not being tested.

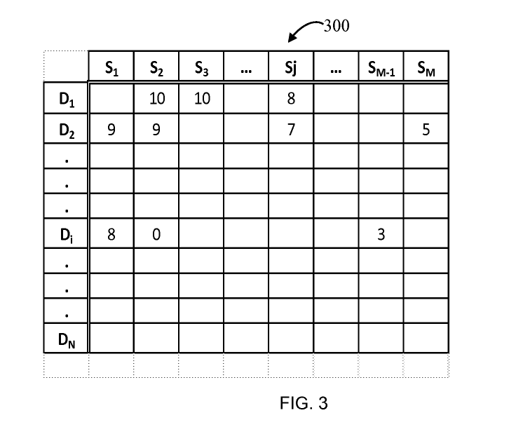

Another embodiment of the compatibility matrix is shown in FIG. 3 where a degree of compatibility is stored for a pair of a mobile device and a service in the matrix 300 and stored in database 125. In this embodiment the PCS is in a form of discrete values. For example, the definite compatibility is shown in matrix 300 as a PCS of ‘10’ and a definite incompatibility as a PCS of ‘0’. A score in between denotes a lower level of compatibility as the PCS is lower. For example, a user requiring the service S₁ is less likely to consider device model Dⱼ as this device model has a lower compatibility to that service than the device model D₂. In one embodiment of the invention, the compatibility matrix (either matrix 200 or 300) may be utilized to recommend certain device models to a particular service. For example, recommending device models D₁ or D₂ over device Dⱼ to a user requiring the service S₂, as this service has a higher degree of compatibility with device D₁ or D₂. It should be noted that a device may have more than one designated name, thus a mapping of different names to an identical device is also provided for. Similarly, a service may have more than one name, and therefore a mapping of different names to an identical service is also provided for. In the exemplary matrix 200 the blank cells represent the case where no determination was made with respect to the compatibility, for example, in the case where no information was available with respect of the pair, or for some other reason not being tested.

The PCS is generated for each pair of a mobile device and a service based on the information gathered and available for such a pair. The information for a mobile device may include an operating system of the mobile device, a version of the operating system, the amount of memory the mobile device has on board, a display type, and more. The service may have requirements, such as specific types of operating systems the service can work on, a minimum amount of memory the service needs, the type of displays the service can display on, and more. If the provider of the service has acknowledged that the service is operable on a device the definite compatibility is recognized. However, for practical reasons it is impossible these days for the developers of services to check each and every mobile device. However, based on the mobile devices characteristics and the service requirements, as well as other information available, for example, indication on the world-wide-web that confirms compatibility by a third party testing, that a prediction can be made as to the operability of a service on a specific mobile device. Such information is provided by the means of the PCS, thereby enabling a user to determine the amount of risk involved when attempting to eventually install a service on a specific mobile device.

As a non-limiting example, a service requiring a specific operating system, a minimum amount of memory, and a minimum display size, may not have been validated on a specific mobile device that has all these characteristics, thus a PCS of ‘10’ would not apply, however, because the likelihood for compatibility is relatively high the system server 120 may assign a score of ‘8’ to the service. If the mobile device uses a different operating system, then it is very unlikely that the service will operate on the mobile device, thus the score can be as low as ‘0’ or ‘1’. However, if the amount of memory is on the border line, but other requirements are sufficient, the server 120 may assign a PCS of ‘5’.

Returning to FIG. 1, the system server 120 requests information, respective of mobile devices from, for example, a web server 140, and collects information about the mobile device capabilities. The system server 120 also requests information respective of services for mobile devices, for example from a web server 140. The system server 120 matches the information collected and then generates a score respective of a pair of a mobile device and a service. The score may be updated periodically as additional information is gathered. This enables continuous update of the compatibility matrix as additional information about the mobile device and the service are made accessible. Furthermore, upon such periodic update of the compatibility matrix, the system server 120 together with terminal device 130 may automatically install new services found to be compatible with a certain mobile device model on mobile devices that do not have the service currently installed. In another embodiment of the invention, the system server 120 may notify a user of a mobile device on an existence of a new service that was found to be operable on the mobile device and allow the user of the mobile device to enable the installation thereon.

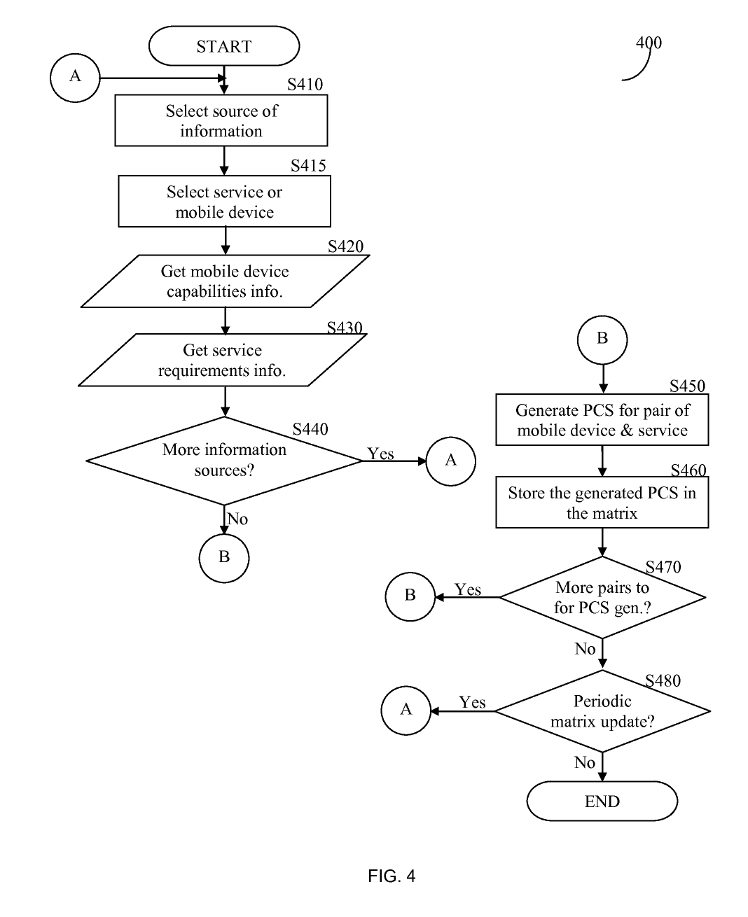

FIG. 4 depicts an exemplary and non-limiting flowchart 400 of the method for generating a compatibility matrix implemented in accordance with an embodiment of the invention. In S410, a source of information is selected. The source of information can provide information regarding either a mobile device or a service. The source of information may be, but is not limited to, a web server 140, a mobile device, the compatibility matrix (such as the matrix shown in FIG. 2 or FIG. 3), the database 125, and other appropriate sources of information.

In S415 either a service or a device is selected. In one embodiment of the invention only a combination of a device and service not currently having a definitive PCS in the compatibility matrix is selected. In another embodiment, despite the existence of a PCS, a pair is selected to enable update of the PCS. It is further to be understood that the existence of the service and/or the device on the compatibility matrix is not required, and if either the service or the device do not exist on the matrix, a row or a column is added to the compatibility matrix for that purpose. In S420 information respective of capabilities of one or more mobile devices are gathered, for example, by the system server 120. In S430 information respective of requirements of one or more services are gathered, for example, by system server 120.

In S440 it is checked whether additional sources of information are to be accessed, and if so execution returns to S410; otherwise, execution continues with S450. In S450 a PCS is generated for a pair of service and mobile device based on information gathered with respect of the service and the mobile device. In S460, the generated PCS is stored in the compatibility matrix at a position that is the intersection of the service and the mobile device. The compatibility matrix is kept, for example, in the database 125. In S470 it is checked whether another PCS is to be generated for a pair of service and mobile device, and if so execution continues with S450; otherwise, execution continues with S480.

In S480 it is checked whether periodic updates of the compatibility matrix are necessary and if so execution returns to S410; otherwise, execution terminates. Therefore, it should be apparent that the method described herein further teaches a learning capability of the system 100 as it adjusts a higher degree of prediction capability as the system refines the content of the matrix through repeated investigation of information sources.

In one embodiment of the invention the system 100 is used for the purpose of evaluation of the amount of effort required to support an application or a service on all applicable mobile devices. This is done by accessing a matrix generated in accordance with the principles of the invention. As the matrix, for example the matrix described with respect of FIG. 3, contains compatibility predictions by means of the PCS, it is possible to create a list that contains all those cases where a prediction for compatibility was made and that is less than a definitive compatibility but above a predefined threshold. All the devices in the list can then be submitted to any required tests to ascertain compatibility. In this way a provider of a service or a provider of a mobile device, can easily identify either devices or services, as may be applicable, that require further testing but that the prediction score is sufficiently high to warrant the expense associated with the initiation of such a test process.

The principles of the invention may be implemented in hardware, firmware, software or any combination thereof. Moreover, the software is preferably implemented as an application program tangibly embodied on a program storage unit or computer readable medium. One of ordinary skill in the art would recognize that a “machine readable medium” is a medium capable of storing data and can be in a form of a digital circuit, an analogy circuit or combination thereof, but not limited thereto. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various methods, processes and functions described herein may be either part of the microinstruction code or part of the application program, or any combination thereof, embodied in tangible medium, and which may be executed by a CPU, whether or not such computer or processor is explicitly shown. In addition, various other peripheral units may be connected to the computer platform such as an additional data storage unit and a printing unit.

The foregoing detailed description has set forth a few of the many forms that the invention can take. It is intended that the foregoing detailed description be understood as an illustration of selected forms that the invention can take and not as a limitation to the definition of the invention. It is only the claims, including all equivalents that are intended to define the scope of this invention.

1. An apparatus for determining compatibility between a service and a mobile device, comprising:
a system server for accessing at least one source of information for retrieving information about at least one of capabilities of the mobile device and requirements of the service and determining a predictive compatibility score (PCS) based on the retrieved information, wherein the PCS provides an indication on an ability of the service to successfully execute on the mobile device; and
a database connected to the system server and containing a two dimensional compatibility matrix, wherein the PCS is stored in the compatibility matrix.

2. The apparatus of claim 1, wherein the at least one source of information is at least one of: at least one web site, at least one mobile device, the compatibility matrix, and the database.

3. The apparatus of claim 1, wherein the system server periodically queries the at least one source of information for capabilities of the mobile device.

4. The apparatus of claim 1, wherein the system server periodically queries the at least one source of information for requirements of the service.

5. The apparatus of claim 1, wherein the PCS is one of: a ‘compatible’ string and an ‘incompatible’ string.

6. The apparatus of claim 5, wherein the PCS is further a ‘maybe’ string.

7. The apparatus of claim 1, wherein the PCS comprises a plurality of discrete values where an extreme value on one end denotes definite compatibility and an opposite extreme value denotes a definite incompatibility.

8. The apparatus of claim 1, wherein responsive of receiving a query the system server provides the PCS of a service and a respective mobile device or vice versa.

9. The apparatus of claim 1, wherein the system server accesses the at least one source of information through an interface, wherein the interface is at least one of: a local area network (LAN), a wide area network (WAN), a metro area network (MAN), the world-wide-web (WWW), the Internet, a cellular network, and a wireless network.

10. The apparatus of claim 1, wherein the system server periodically checks the PCS and updates the PCS thereafter, thereby providing a learning capability of the apparatus.

11. The apparatus of claim 10, wherein responsive of the update of the PCS the apparatus performs at least one of: installs a service on the mobile device where the PCS indicates sufficient compatibility, provides an indication on the mobile device that a compatible service has been identified for a model of the mobile device.

12. The apparatus of claim 1, wherein the database further contains at least one of: a mobile devices relations matrix and a services relations matrix.

13. A method for determining compatibility between a service to a mobile device, comprising:
selecting at least one source of information for information respective of at least one of capabilities of the mobile device and requirements of the service;
retrieving the information respective of the at least one of capabilities of the mobile device and requirements of the service from the at least one source of information;
determining a predictive compatibility score (PCS) for a pair of the mobile device and the service based on the retrieved information; and
storing the PCS in a compatibility matrix at a position corresponding to the intersection of the mobile device and the service, wherein the compatibility matrix contains a PCS for each pair of mobile device and service if information is available to make a PCS determination for such a pair.

14. The method of claim 13, further comprises:
causing the test of the service on the mobile device for positive determination of compatibility.

15. The method of claim 13, wherein the at least one source of information is at least one of: at least one web site, at least one mobile device, and the compatibility matrix.

16. The method of claim 13, further comprises:
periodically updating at least a PCS stored in the compatibility matrix.

17. The method of claim 13, further comprises:
generating a PCS that is one of: a ‘compatible’ string and an ‘incompatible’ string.

18. The method of claim 17, further comprising:
generating a PCS that is a ‘maybe’ string.

19. The method of claim 13, further comprises:
generating a PCS that comprises a plurality of discrete values where an extreme value on one end denotes a definite compatibility and an opposite extreme value denotes a definite incompatibility.

20. The method of claim 13, further comprises:
receiving a query; and
providing the PCS for a service and a respective mobile device or vice versa responsive of the query.

21. The method of claim 13, further comprises:
periodically checking the PCS; and
updating the PCS if the PCS has been changed.

22. The method of claim 21, further comprises:
installing a service on a mobile device, upon determination of sufficient compatibility.

23. The method of claim 21, further comprises:
providing an indication to a mobile device that a compatible service has been found for a model of the mobile device.

24. The method of claim 13, further comprises:
assigning a PCS threshold value;
identifying all services for a mobile device having a PCS that is less than definitive compatibility of a service to the mobile device and above the PCS threshold;
and displaying the identified services as candidates for compatibility testing for the mobile device.

25. The method of claim 13, further comprises:
assigning a PCS threshold value;
identifying all mobile devices for a service having a PCS that is less than definitive compatibility of a service to the mobile device and above the PCS threshold; and
displaying the identified mobile devices as candidates for compatibility testing for the service.

26. The method of claim 13, further comprises:
identifying relations between mobile devices; and
storing the identified relations between mobile devices in a mobile devices relations matrix.

27. The method of claim 13, further comprises:
identifying relations between services; and
storing the identified relations between services in a services relations matrix.
